(19) United States
(12) Patent Application Publication
(10) Pub. No.: US 2006/0081723 A1
(43) Pub. Date: Apr. 20, 2006

(54) System for chemical dispersion

(76) Inventor: Roger Turberville, Uriah, AL (US)

Correspondence Address: VENABLE LLP, P.O. BOX 34385, WASHINGTON, DC, 20045-9998, US

(21) Appl. No.: 11/249,509

(22) Filed: Oct. 14, 2005

Related U.S. Application Data
(60) Provisional application No. 60/618,601, filed on Oct. 15, 2004.

(51) Int. Cl. B05B 1/24

(52) U.S. Cl. 239/129

(57) ABSTRACT

A heat exchanger including a nozzle having a first inlet adapted to receive a pressurized chemical and a second inlet adapted to receive a pressurized gas. The pressurized chemical combines with the pressurized gas in the nozzle to form a mist. A chamber heated by a heated gas and being coupled to the nozzle. The heated gas vaporizes at least a portion of the mist within the chamber to create a fog.

### BACKGROUND OF THE INVENTION

1. Field of the Invention

The invention described herein relates to chemical dispersion, and in particular relates to an apparatus and method of creating and dispersing a chemical fog.

2. Related Art

It is a common problem to have to disperse a chemical over a broad area for purposes such as pest control or weed control. Conventional systems for chemical dispersion convert the chemical (e.g., a pesticide or herbicide) into a spray. The chemical spray can then be applied over an area in an attempt to address the problem. However, spraying can only cover a limited area. The range of a spray is constrained by the distance over which the individual droplets of the spray can be propelled.

What is needed is an improved system for dispersing a chemical over a broad area.

### SUMMARY OF THE INVENTION

The invention described herein converts a chemical (such as a pesticide or herbicide) into a fog, then disperses the fog over a wide area.

The present invention includes a heat exchanger, an apparatus including a heat exchanger, and a method for generating a chemical fog.

The heat exchanger may comprise a nozzle having a first inlet adapted to receive a pressurized chemical and a second inlet adapted to receive a pressurized gas. The pressurized chemical may combine with the pressurized gas in the nozzle to form a mist. A chamber may be heated by a heated gas and may be coupled to the nozzle, wherein the heated gas may vaporize at least a portion of the mist within the chamber to create a fog.

The apparatus may comprise an engine adapted to produce a heated gas and a heat exchanger coupled to the engine and being adapted to receive the heated gas. The heat exchanger may comprise a nozzle having a first inlet adapted to receive a pressurized chemical and a second inlet adapted to receive a pressurized gas, wherein the pressurized chemical combines with the pressurized gas in the nozzle to form a mist. The heat exchanger may also include a chamber heated by the heated gas and being coupled to the nozzle, wherein the heated gas vaporizes at least a portion of the mist to create a fog.

The method may include receiving a pressurized chemical at a first inlet, receiving a pressurized gas at a second inlet, combining the first chemical with the second gas to form a mist, heating a chamber with a heated gas, and vaporizing at least a portion of the mist in the chamber to generate a fog.

Further objectives and advantages of the invention, as well as preferred embodiments, will become apparent from consideration of the following description, drawings, and examples provided herewith.

### BRIEF DESCRIPTION OF THE FIGURES

The foregoing and other features and advantages of the invention will be apparent from the following, more particular description of a preferred embodiment of the invention, as illustrated in the accompanying figures. In the drawings, like reference numbers generally indicate identical, functionally similar, and/or structurally-related elements.

FIG. 1 illustrates a cross sectional front and side view of an exemplary embodiment of a heat exchanger according to the present invention;

FIG. 2 includes an exploded view of an expansion chamber and a heat exchanger nozzle of the heat exchanger according to an exemplary embodiment of the present invention;

FIG. 3 illustrates an exploded view of a fog exit nozzle and an expansion tube of the heat exchanger according to an exemplary embodiment of the present invention;

FIGS. 4A-4E illustrate an exemplary apparatus incorporating the heat exchanger according to the present invention;

FIG. 5 illustrates an exemplary apparatus with a plastic housing of the apparatus being detached according to the present invention;

FIGS. 6A-6C illustrate an exemplary embodiment of a system for attaching a chemical can to the apparatus according to the present invention;

FIG. 7 illustrates an exemplary embodiment of a fogger wand attachable to the apparatus according to the present invention;

FIG. 8 illustrates an exemplary embodiment of a receptacle for the fogger wand according to the present invention; and

FIG. 9 illustrates an enlarged view of an exemplary embodiment depicting openings in a receptacle tube according to the present invention.

### DETAILED DESCRIPTION OF THE INVENTION

Exemplary embodiments of the invention are discussed in detail below. In describing the embodiments, specific terminology is employed for the sake of clarity. The invention is not intended to be limited to the specific terminology so selected. While specific exemplary embodiments are discussed, it should be understood that this is done for illustration purposes only. A person skilled in the relevant art will recognize that other components and configurations can be used without departing from the spirit and scope of the invention.

A better approach of dispersing chemicals than using a chemical spray is to use a chemical fog for chemical dispersion. A fog may be easily spread over a broad area, while spray droplets cannot. In an exemplary system, a chemical may be converted from a liquid into a much finer mist, approaching a vapor state. While a fog may be superior to a chemical spray, known processes of converting a chemical to a fog are inefficient. Ideally, all or nearly all of the chemical is converted into a fog form. Failure to convert all of the chemical into a fog results in some of the chemical staying in liquid or droplet form. In droplet form, the chemical cannot be easily spread over a wide area. Therefore, a need exists for a system that creates and distributes a chemical fog over a broad area and that has a high efficiency of converting a chemical into a fog.

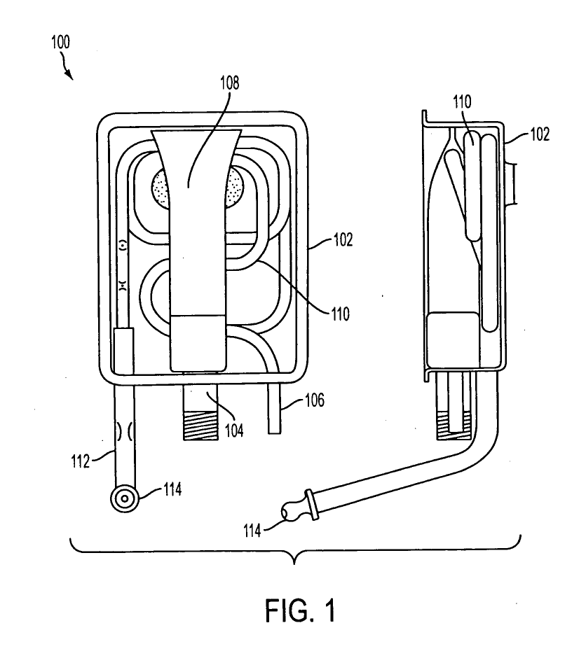

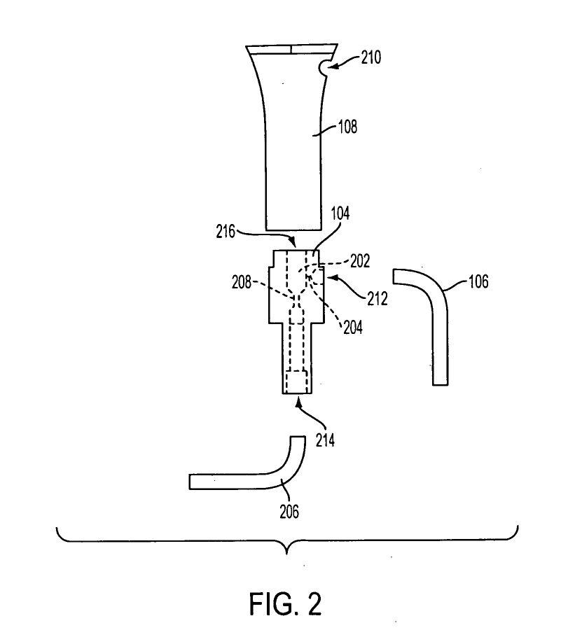

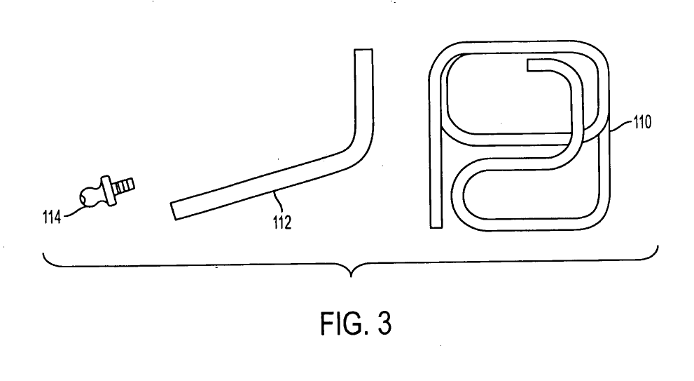

The present invention relates to a heat exchanger for generating a chemical fog. The generated chemical fog may be used to spread a herbicide, an insecticide, or other chemicals over an area, as will be appreciated by those skilled in the art. Initially, the invention will be described in FIGS. 1-3. FIG. 1 illustrates a cross sectional front and side view of an exemplary embodiment of a heat exchanger according to the present invention. FIG. 2 includes an exploded view of an expansion chamber and a heat exchanger nozzle of the heat exchanger according to an exemplary embodiment of the present invention. FIG. 3 illustrates an exploded view of a fog exit nozzle and an expansion tube of the heat exchanger according to an exemplary embodiment of the present invention.

In FIG. 1, a heat exchanger 100 is depicted that is mountable in and/or to an engine muffler (not shown). Alternatively, the heat exchanger 100 may be a separate part that may replace the muffler. The heat exchanger 100 may externally and/or internally receive heat from hot exhaust gas produced by the engine and use the heat to convert a chemical into a fog, as will be described later in detail. It is noted that the fog substantially does not include the exhaust gas. Rather, the heat of the exhaust gas is only used as a heat source for the exterior of the components of the heat exchanger 100 when converting the chemical into a fog. This eliminates the possibility of creating undesirable engine backpressure in the muffler potentially caused by expansion characteristics of the chemical. It also would not affect a warranty of the engine, and does not alter the Environmental Protection Agency (EPA) emission requirements of the engine. Additionally, keeping the exhaust separate from the chemical eliminates the possibility of a chemical/exhaust fire.

A heat exchanger shell 102 is the outer housing of the heat exchanger 100. The heat exchanger shell 102 may take many shapes for different engine styles, as will be appreciated by those skilled in the art. In the depicted embodiment, the heat exchanger shell 102 includes a heat exchanger nozzle 104 that leads into the heat exchanger shell 102, an expansion chamber 108, a chemical supply line 106 that leads into the heat exchanger nozzle 104, an expansion tube 110, and a fog exit tube 112 that leads out of the heat exchanger shell 102.

In FIG. 2, the heat exchanger nozzle 104 includes an inlet 212 for receiving the chemical supply line 106, a chemical port 204, an inlet 214 for receiving an air supply line 206, an air port 208, and an output 216 that leads into the expansion chamber 108. A nozzle chamber 202 is included within the heat exchanger nozzle 104 and may receive air and chemicals from the chemical supply line 106 and the air supply line 206, respectively. In one embodiment, the chemical supply line 106 and the air supply line 206 are composed of rubber. The inlet 212 for the chemical supply line 106 narrows as it approaches the chemical port 204, and the inlet 214 for the air supply line 206 narrows as it approaches the air port 208. The bottom of the expansion chamber 108 may be coupled with the top of the heat exchanger nozzle 104 such that the top of the heat exchanger nozzle 104 extends into the base of the expansion chamber 108. Other couplings of the expansion chamber 108 and the heat exchanger nozzle 104 may be used, as will be appreciated by those skilled in the art. The expansion chamber 108 is hollow in the center and includes an opening 210 near the top for coupling with the expansion tube 110.

The expansion tube 110 is coupled between the expansion chamber 108 and the fog exit tube 112. As depicted in FIGS. 1 and 3, the expansion tube 110 curves within the heat exchanger shell 102. The expansion tube 110 is composed of a material that may withstand the temperatures of heat from engine exhaust gas. In an embodiment of the invention, the expansion chamber 108 and the expansion tube 110 may be composed of metal, including, but not limited to, copper, stainless steel, or another suitable material as will appreciated by those skilled in the art.

The fog exit tube 112 is coupled to one end of the expansion tube 110 and leads out of the heat exchanger shell 102. A fog exit nozzle 114 may be coupled at and/or removed from the end of the fog exit tube 112 outside of the heat exchanger shell 102, as illustrated in FIGS. 1 and 3. The fog exit nozzle 114 includes a hole therethrough for emitting fog received from the heat exchanger 100. The fog exit nozzle 114 also provides an attachment point for accessories, as will be discussed later in detail.

In operation, the heat exchanger 100 receives air, chemicals, and heat to generate a fog. Air passes into the heat exchanger nozzle 104 from the air supply line 206 and flows into the base of the heat exchanger nozzle chamber 202 at the inlet 212 and through the air port 208. The narrowing of the air passage from the inlet 214 to the air port 208 causes a venturi effect within the heat exchanger nozzle chamber 202. The venturi effect results in an increase in the velocity of the air flow and a corresponding decrease in air pressure that creates suction into the heat exchanger nozzle chamber 202. When the heat exchanger nozzle 104 is also receiving chemicals from the chemical supply line 106, the venturi effect atomizes the chemical passing through the chemical port 204, which results in a mist that exits the top of the heat exchanger nozzle 104 and enters the expansion chamber 108.

Using an air atomizing as described in this embodiment allows for a faster and more complete conversion of chemical into fog. Pressurized air pressurizes the chemical in the heat exchanger 100 and is highly efficient in the use of the chemical. Initially, the chemical may be in liquid form. Atomizing the chemical separates the chemical into smaller droplets for increased chemical to fog conversion efficiency. This efficiency occurs since smaller chemical droplets convert to a fog at a faster rate as compared with larger droplets. Separating the chemical into smaller droplets also prevents any liquid from exiting the heat exchanger 100.

While running, the engine (not shown) generates exhaust gas that heats the heat exchanger shell 102 and the components therein. As the chemical mist enters the heated expansion chamber 108, at least a portion of the chemical mist is vaporized due to the heat and begins to expand into a fog. The fog and at least some of the remaining unvaporized chemical mist may exit the expansion chamber 108 at the opening 210 and enter the expansion tube 110, where at least some of the remainder of the chemical mist and/or fog continues to expand into a fog because of the heated exterior of the expansion tube 110. This heating process in the expansion chamber 108 and in the expansion tube 110 substantially coverts all of the chemical into a fog. The fog travels through the expansion tube 110 and exits the heat exchanger 100 at the fog exit tube 112. The fog may then be emitted by the fog exit tube 112 at the fog exit nozzle 114.

It is noted that depending on the type of engine used, a pre-heating cycle for the engine may be necessary in order to preheat the heat exchanger 100 prior to fog generation, which ultimately may provide a more efficient creation of chemical fog. In one embodiment, a ceramic heat catalyst may be used to pre-heat the heat exchanger 100. The ceramic heat catalyst may be a heat bank. The ceramic heat catalyst may be located in the expansion chamber 108 so that all of the chemical passes therethrough. The ceramic heat catalyst may be used to quickly pre-heat the heat exchanger 100, and provide a more uniform heat conversion area within the heat exchanger 100. The ceramic heat catalyst also outputs a substantially uniform heat level that offsets the cooling effect of the chemical within the heat exchanger 100. The uniform heat level allows for a more complete and faster conversion of the chemical into a fog. Passing the chemical through the ceramic heat catalyst ensures that substantially all of the chemical is converted into a fog. Thus, the heat exchanger 100 provides better quality and more efficient conversion of chemical into a fog than known solutions.

In order to emit the fog from the fog exit nozzle 114, the pressure within the heat exchanger 100 must be regulated since expansion of the chemical mist into a fog produces backpressure within the expansion chamber 108. Without sufficient chemical pressure from the chemical supply line 106 and air pressure from the air supply line 206, the backpressure would cause some of the chemical mist and/or fog to exit out of the expansion chamber 108 into the heat exchanger nozzle 104 and back into the chemical supply line 106 and the air supply line 206. The pressure of the chemical received in the chemical supply line 106 and of the air received in the air supply line 206 at the heat exchanger nozzle 104 may be used to overcome at least a portion of the backpressure in order to emit the fog from the fog exit nozzle 114. In one embodiment, the chemical is pressurized to approximately 4.5-6 pounds per square inch (psi) in the chemical supply line 106 and the air is pressurized to approximately 10-15 psi in the air supply line 206. The pressure of the chemical in the chemical supply line 106 may range from 4.5-6 psi, but may be as low as 4.5 psi, and as high as 6.5 psi. The pressure in the air supply line 206 may range from 10-15 psi, but may be as low as 8 psi, and may be as high as 15 psi. Other pressures may be used so long as they overcome the backpressure generated by the expansion of the chemical fog within the expansion chamber 108, as will be appreciated by those skilled in the art.

The fog exit nozzle 114 and the fog exit tube 112 may also control a portion of the backpressure within the heat exchanger 100. The fog exist nozzle 114 controls backpressure based on the diameter of the opening included therethrough, and the flow rate of the fog through the expansion tube 110, which is proportional to the diameter of the expansion tube 110, to maintain a constant backpressure in the expansion chamber 108. The diameters of the expansion tube 110 and of the fog exit nozzle 114 may be varied to control the backpressure, as will be appreciated by those skilled in the art.

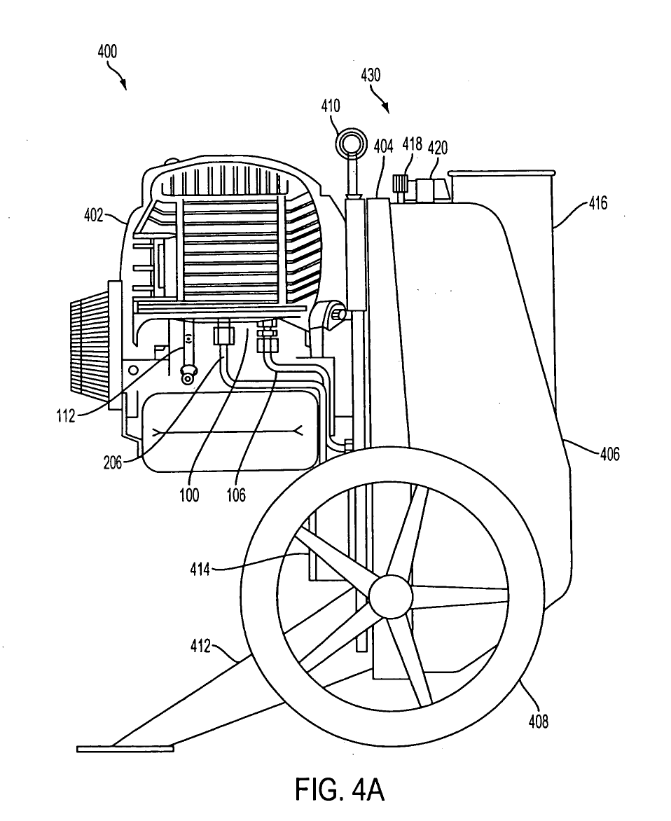

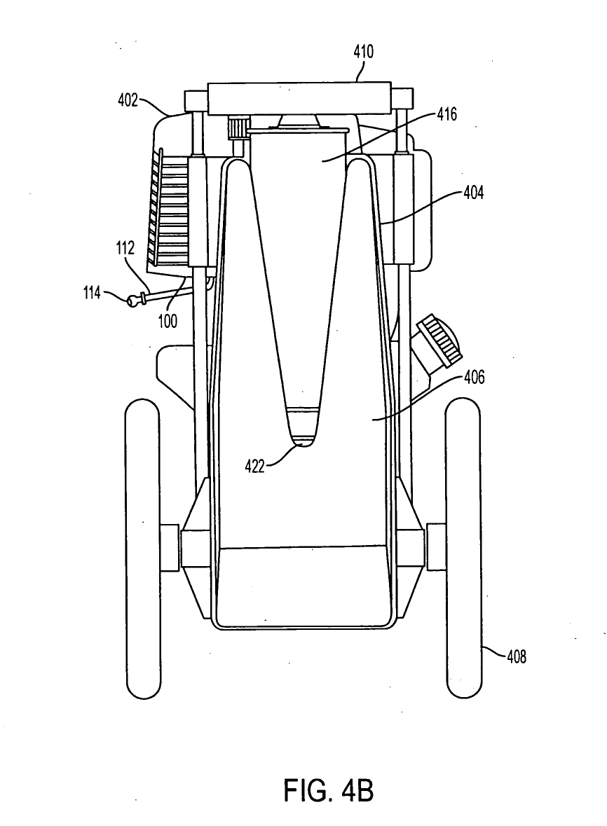

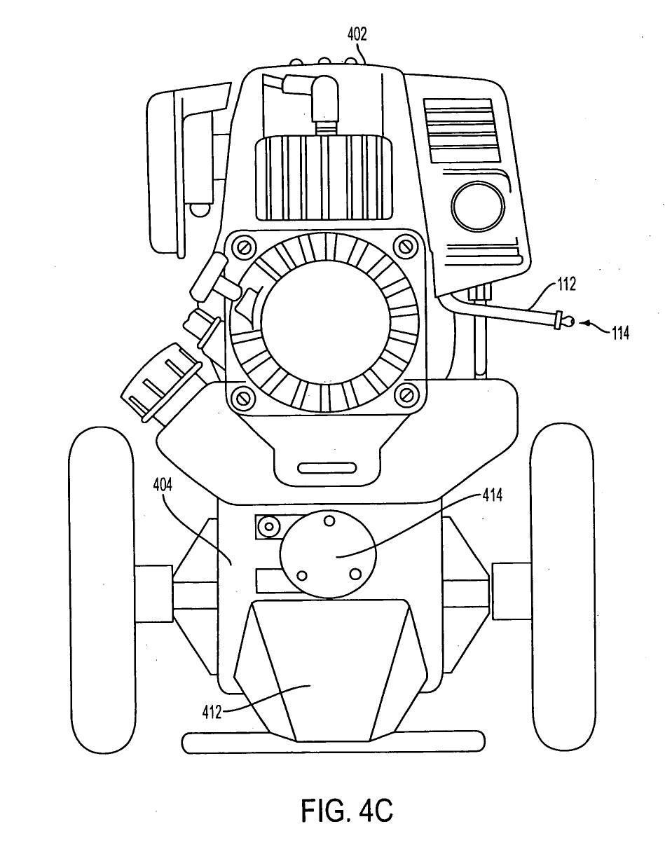

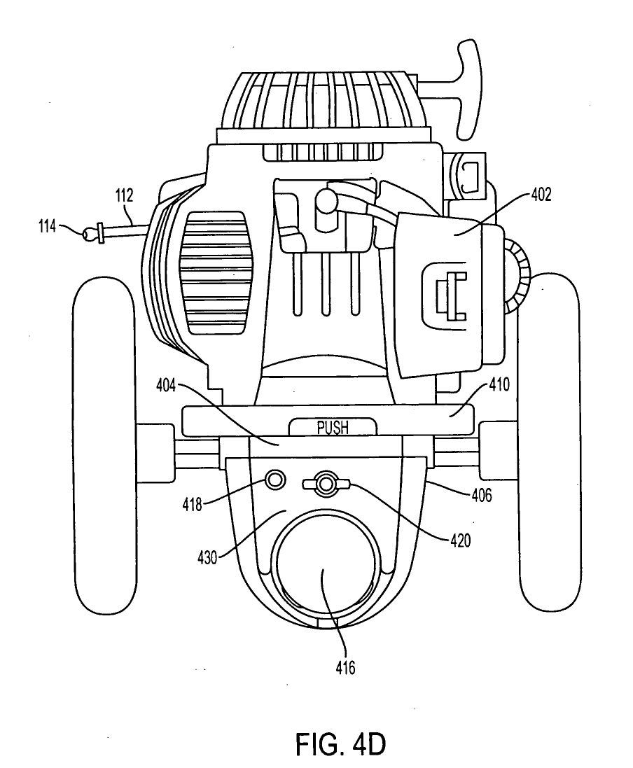

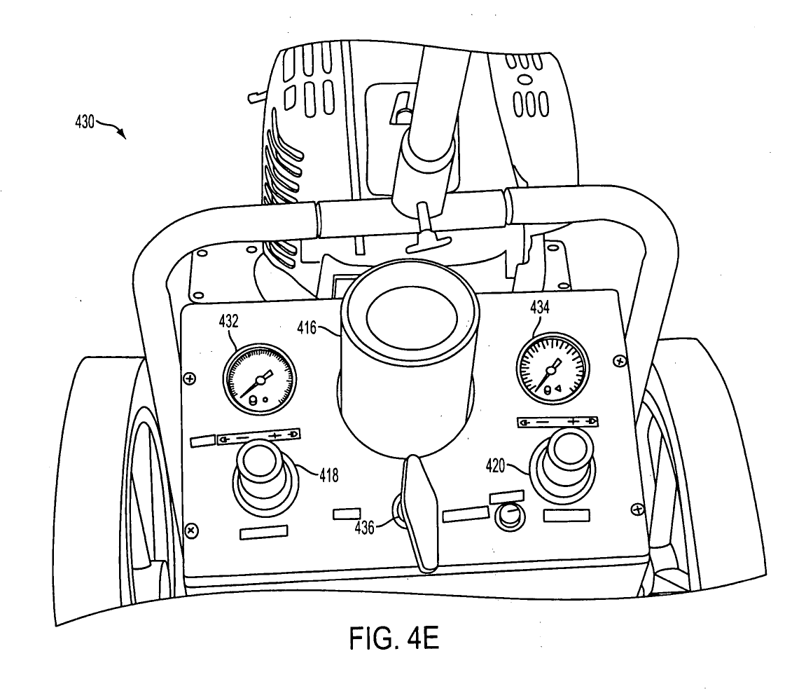

The heat exchanger 100 may also be integrated into an apparatus, as described below. FIGS. 4A-4D depict an exemplary embodiment of an apparatus 400 including the heat exchanger 100 according to the present invention. FIG. 4A illustrates a side view of the apparatus, FIG. 4B illustrates a rear view, FIG. 4C illustrates a front view, and FIG. 4D illustrates a top view. The following refers to FIGS. 4A-4D.

In one embodiment depicted in FIG. 4A, an apparatus 400 includes an engine 402 coupled to a frame 404. The engine may be an internal combustion engine, a 4-cycle engine, or any other known engine that outputs sufficient heat to vaporize the desired chemical and to convert the chemical into a fog, as will be appreciated by those of skill in the art. The engine 402 is coupled to the heat exchanger 100 and provides the heat exchanger 100 with heat from hot exhaust gas in order to generate the chemical fog.

The frame 404 is generally adapted to support the engine 402 and to allow for transport of the apparatus 400. The frame 404 may include a foot rest 412, one or more wheels 408, an adjustable handle 410, and a plastic housing 406. The foot rest 412 is adapted to stabilize the apparatus 400 in an upright position. The foot rest 412 can be on the same side as, and positioned below, the engine 402. In the embodiment depicted in FIG. 4A, the weight of the engine 402 creates down force against the base of the footrest 412 so that the apparatus 400 is balanced on the one or more wheels 408 and the foot rest 412, thereby allowing the apparatus 400 to stand upright.

The adjustable handle 410 is used for transporting the apparatus 400 and may include a hand grip and/or a release button. The adjustable handle 410 may be adjusted from a completely expanded position to a completely collapsed position. The adjustable handle 410 is a telescoping handle that locks into the extended position for pulling and can be collapsed and locked into the down position for lifting and storing. The button (see FIG. 4D) may be pressed to release the lock. The completely collapsed position is depicted in FIG. 4A.

During transport of the apparatus 400, a user extends the adjustable handle 410 to a desired height and pulls on the adjustable handle 410 at the hand grip to elevate the foot rest 412 from contacting the ground. The user would then pull and transport the apparatus 400 using the one or more wheels 408 in the direction opposite that which the engine 402 faces.

The plastic housing 406 is used to cover and protect the internal components of the apparatus 400 and to receive a chemical can 416. The plastic housing 406 includes a control panel 430 for controlling the amount of fog generated by the apparatus 400 during fog dispersion. The control panel 430 may include one or more controls or gauges. The controls may be used to control the pressure (psi) of the air within the air supply line 206 and/or to control the pressure (psi) of the chemical supply line 106. The controls may also be used to control an air flow rate or a chemical flow rate. The pressure and/or flow rate may be generated by one or more rotary air pumps 414 coupled to the frame 404. In one embodiment, the rotary air pump 414 is a non-pulsation rotary air pump, which may not, for example, produce a pulse like a piston pump. In an alternative embodiment, the rotary air pump is a rotary vane air compressor.

As depicted in FIG. 4D, the control panel 430 includes a fog control 420 and an air pressure regulator 418. In one embodiment, the fog control 420 may be a tee handle that may be rotated to control the flow of chemical from the chemical can 416. If the chemical flow is turned to an off setting, no chemical is permitted to flow from the chemical can 416 and no fog is produced. Similarly, the air pressure regulator 418 may be a knob that is user adjustable to control the amount of air pressure within the air supply line 206. Other controls and/or knobs may be included in the control panel 430 for regulating fog generation, as will be appreciated by those skilled in the art. In an alternative embodiment, the apparatus 400 may automatically regulate the amount of fog production without user adjustable controls using backpressure sensors and/or other inputs received from a user on the desired amount of fog generation, as will be appreciated by those skilled in the art.

FIG. 4E illustrates an alternate embodiment for a control panel according to an exemplary embodiment of the present invention. Control panel 430 includes the air pressure regulator 418, the fog control 420, an air gauge 432, a chemical gauge 434, and a starter switch 436. The starter switch 436 may be turned to an on position for manually or automatically starting the engine 402. The air gauge 432 and the chemical gauge 434 may be used to indicate the amount of air pressure and/or the chemical pressure. The air gauge 432 and the chemical gauge 434 may be digital and/or analog displays. Other gauges, sensors, displays, or some combination thereof, may be used on the control panel 430, as will be appreciated by those skilled in the art.

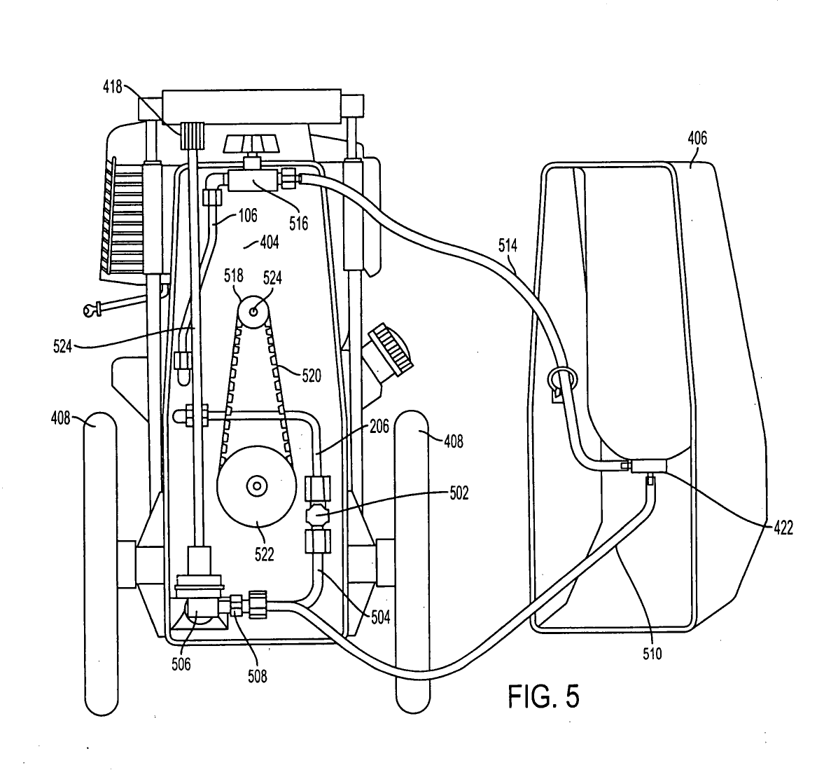

FIG. 5 illustrates an exemplary embodiment of the plastic housing 406 being detached from the frame 404 to further illustrate the apparatus 400 and the system for regulating the pressure within the apparatus 400 according to the present invention. The system depicted in FIG. 5 is a pressure controlled fluid system that provides sufficient chemical pressure in the chemical supply line 106 and sufficient air pressure in the air supply line 206 to overcome the backpressure caused by expansion of the chemical mist into a fog within the expansion chamber 108.

As shown, a user may control the amount of air pressure in the apparatus 400 using the rotary air pump 414, which is powered by the engine 402. As the engine runs, it rotates a timing belt 520 that extends along the outer edge of a first circular timing belt pulley 518 and of a second circular timing belt pulley 522. The first circular timing belt pulley 518 rotates about a Power TakeOff (PTO) shaft 524. The second circular timing belt pulley 522 is affixed to an input shaft of the rotary air pump 414. The rotation of the timing belt 520, the first circular timing belt pulley 518, and the second circular timing belt pulley 522 produces air pressure by the turning of the rotary air pump 414. The pressurized air output from the rotary air pump 414 enters a tee style compression tubing fitting 502, which separates the pressurized air into two paths. The first path controls the air pressure of the air supply line 206, and the second path controls the chemical pressure in the chemical supply line 106, as described below.

A rod 524 extends from the air pressure regulator 418 to an air pressure regulator 506. Pressurized air passes through the tee style compression tubing fitting 502 and is directed to the first path and to the second path. The first path of pressurized air is the air supply line 206 that leads into the heat exchanger 100. The second path leads through an air supply line 504 to the air pressure regulator 506. In one embodiment, the air supply line 504 is composed of rubber. A back flow air check valve 508 couples the air pressure regulator 506 with an air supply line 510. In one embodiment, the air supply line 510 is composed of rubber. The back flow air check valve 508 controls the direction of the pressurized air as it passes through the air pressure regulator 506. The back flow air check valve 508 only permits pressurized air to pass from the air pressure regulator 506 to the air supply line 510, and prevents chemicals and/or other fluids from flowing into the air pressure regulator 506 during storage.

From the back flow air check valve 508, air passes through the air supply line 510 into a needle and hose hub assembly 422, which may be mounted to the plastic housing 406. The needle and host hub assembly 422 is the attachment point of the chemical can 416 to the apparatus 400. From the needle and hose hub assembly 422, a chemical supply line 514 extends to a fluid valve 516. In one embodiment, the chemical supply line 514 is composed of rubber. The fluid valve 516 is coupled to the fog control 420 and is used to regulate whether the chemical may pass from the chemical can 416 to the heat exchanger 100. The chemical supply line 106 leads from the fluid valve 516 to the heat exchanger 100.

During operation, air passes into the chemical can 416 when the chemical can 416 is attached to apparatus 400 and the air pressure regulator 418 is permitting pressurized air to flow into the air supply line 510. The air is released into the chemical can 416, which raises the internal pressure of the chemical can 416 and forces the chemical to flow out of the chemical can 416 and into the chemical supply line 514. The chemical passes through the chemical supply line 514 to the fluid valve 516. When fog is desired, the fog control 420 is turned to open the fluid valve 516, which permits chemical to flow through the chemical supply line 106 into the chemical port 204 of the heat exchanger nozzle 104.

As air pressure to the chemical can 416 is increased by rotating the air pressure regulator 418, this increases the amount of chemical forced through the heat exchanger nozzle 104 to be atomized at the nozzle chamber 202 and may be used to control the amount of chemical produced by the apparatus 400. For example, increasing the amount of chemical increases the amount of fog emitted by the apparatus 400 at the fog exit nozzle 114.

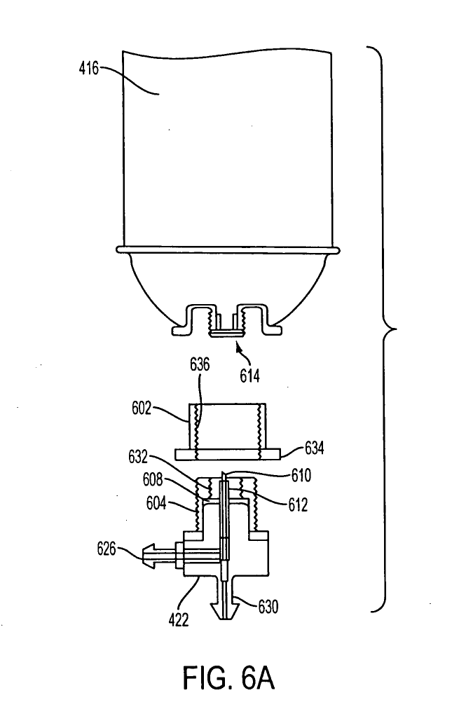

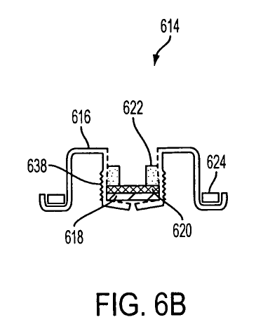

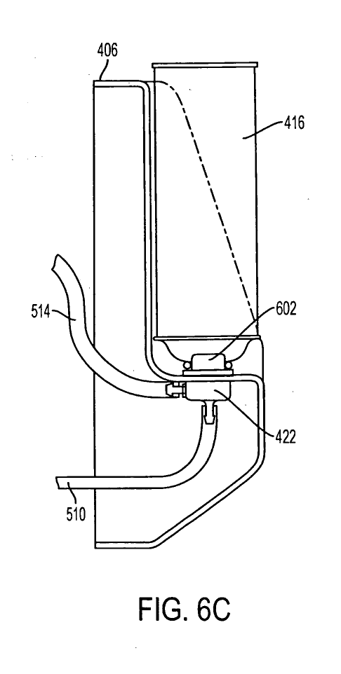

FIGS. 6A-6C illustrate an exemplary apparatus for attaching the chemical can 416 to the apparatus 400 according to the present invention. FIG. 6A depicts an exploded view of the chemical can 416, a can nozzle nut, and a needle and hose hub assembly according to an exemplary embodiment of the present invention. FIG. 6B depicts an enlarged view of a can cap and valve assembly of the chemical can 416 according to an exemplary embodiment of the present invention. FIG. 6C depicts the chemical can 416 attached to the apparatus 400 at the can nozzle nut and the needle and hose hub assembly according to an exemplary embodiment of the present invention. The following description refers to FIGS. 6A-6C.

In FIG. 6C, the chemical can 416, a can nozzle nut 602, and a needle and hose hub assembly 422 may be coupled with one another during attachment of the chemical can 416 to the apparatus 400. The chemical can 416, the can nozzle nut 602, and the needle and hose hub assembly 422 are coupled with one another to permit air to enter the chemical can 416, and to allow the chemical stored within the chemical can 416 to exit the chemical can 416 into the apparatus 400.

The needle and hose hub assembly 422 may be a component of the apparatus 400. In the embodiment depicted in FIG. 6A, the needle and hose hub assembly 422 includes an air input port 630, a chemical output port 626, an inner needle assembly 610, an outer needle assembly 612, an inner threaded collar 632, an outer threaded collar 604, and a seal ring 608. In one embodiment, the seal ring 608 is composed of rubber. The air input port 630 is positioned at the base of the needle and hose hub assembly 422. The air input port 630 is adapted to couple with the air supply line 510 to receive pressurized air from the apparatus 400. The air input port 630 includes an opening that extends from the end of the air input port 630 to the end of the inner needle assembly 610. The air input port 630 is adapted to permit air to flow through the opening in the air input port 630 and to output the air at the inner needle assembly 610 into the attached chemical can 416.

As described above, releasing air into the chemical can 416 creates pressure within the chemical can 416. This forces the chemical out of the chemical can 416 through the region between the inner needle assembly 610 and the outer needle assembly 612. The diameter of the inner needle assembly 610 is slightly smaller than the diameter of the outer needle assembly 612, which permits the chemical to exit out of the chemical can 416 in the space therebetween and out into the chemical output port 626. The chemical output port 626 includes an opening that extends from the end of the chemical output port 626 to the base of the outer needle assembly 612. The chemical output port 626 is adapted to receive chemical from the chemical can 416 after air received through the inner needle assembly 610 is released into the chemical can 416. The chemical then flows out of the chemical output port 626 to the chemical supply line 514 for transport to the fluid valve 516.

The upper region of the needle and hose hub assembly 422 is a cylindrical post having an inner threaded collar 632 and an outer threaded collar 604. The threads of the inner threaded collar 632 are along the inner wall of the cylindrical post, and the threads of the outer threaded collar 604 are along the outer wall of the cylindrical post. The inner threaded collar 632 is adapted for coupling with the chemical can 416, and the outer threaded collar 604 is adapted for coupling with the nozzle nut 602.

In one embodiment, the nozzle nut 602 may be screwed onto the needle and hose hub assembly 422. The nozzle nut 602 is a cylindrical post that couples with the needle and hose hub assembly 422. The nozzle nut 602 includes a lip 634 at the end that screws onto the needle and hose hub assembly 422. The nozzle nut 602 includes a nozzle nut threaded collar 636 on the interior wall of the cylindrical post. When coupling the nozzle nut 602 with the needle and hose hub assembly 422, the nozzle nut threaded collar 636 is twisted onto the outer threaded collar 604 of the needle and hose hub assembly 422. The threads of the nozzle nut threaded collar 636 interlock with the threads of the outer threaded collar 604, thereby preventing the nozzle nut 604 from separating from the needle and hose hub assembly 422 unless the nozzle nut 602 is twisted in the opposite direction.

After the nozzle nut 602 is secured to the needle and hose hub assembly 422, the chemical can 416 may be attached to the needle and hose hub assembly 422. In FIG. 6B, the chemical can 416 includes a can cap and valve assembly 614 for coupling with the needle and hose hub assembly 422 and the nozzle nut 602. The can cap and valve assembly 614 includes a stamped and threaded cap frame 616, a first seal disk 618, a second seal disk 620 with a flapper valve positioned above the first seal disk 618 when the chemical can 416 is inverted, a press retainer 622 for the first seal disk 617 and the second seal disk 620, and a seal ring 624. In one embodiment, the seal ring 624 is composed of rubber. The seal ring 624 seals the contents of the chemical can 416 and the can cap and valve assembly 614 together. The press retainer 622 is pressed against the first seal disk 618 and the second seal disk 620 to retain the seal disks 618, 620 in place.

The can cap and valve assembly 614 includes a cylindrically shaped recess at one end of the chemical can 416. On the innermost wall of the recess, the can cap and valve assembly 614 includes a threaded collar 638 for coupling with the needle and hose hub assembly 422. This configuration of the can cap and valve assembly 614 is adapted to permit the removal of the chemical can 416 from the needle and hose hub assembly 422 without leaking a substantial amount of the chemical from the chemical can 416, as will be described below in detail.

When the chemical can 416 is being attached to the needle and hose hub assembly 422, the chemical can 416 is aligned with the needle and hose hub assembly 422. The plastic housing 406 of the apparatus 400 guides, supports, and aligns the chemical can 416 as it is being inserted into needle and hose hub assembly 422. During insertion, the threaded collar 638 of the can cap and valve assembly 614 is aligned with and screwed onto the inner threaded collar 632 of the needle and hose hub assembly 422. As the chemical can is rotating onto the needle and hose hub assembly 422, the small inner needle assembly 610 pierces and opens the first seal disk 618 and the second seal disk 620 of the can cap and valve assembly 614.

Once the chemical can 416 is fully screwed onto the needle and hose hub assembly 422, the seal ring 608 of the needle and hose hub assembly 422 is pressed against the top of the inner post of the can cap and valve assembly 614. The pressure of the seal ring 608 against the can cap and valve assembly 614 creates a sealed interface which substantially prevents chemical from leaking out of the interface. The chemical can 416 being fully attached to the apparatus 400 is depicted in FIG. 6C.

It is noted that the threads on the cap and valve assembly 614, the nozzle nut 602, and the needle and hose hub assembly 422 may be 7/16 inch diameter threads with 28 pitches/inch. Other thread sizes may be used, as will be apparent to those skilled in the art.

In one embodiment, when the chemical can 416 is being removed from the needle and hose hub assembly 422, a chemical relief vent (not shown) is provided in the needle and hose hub assembly 422 to allow residual fluid to drain from the needle and hose hub assembly 422. This prevents unused chemical from leaking out of the needle and hose hub assembly 422 and into the air supply line 510.

The can cap and valve assembly 614 also includes certain advantageous features. The cap and valve assembly 614 prevents the user from tampering with the chemical can 416 to remove the chemical. The cap and valve assembly 614 also prevents tampering by preventing refill of the chemical can 416. Additionally, when the chemical can 416 is pressurized and the engine 402 is turned off, the flapper valve in the second seal disk 620 closes because of the pressure within the chemical can 416, thus preventing the chemicals from bleeding out of the chemical can 416.

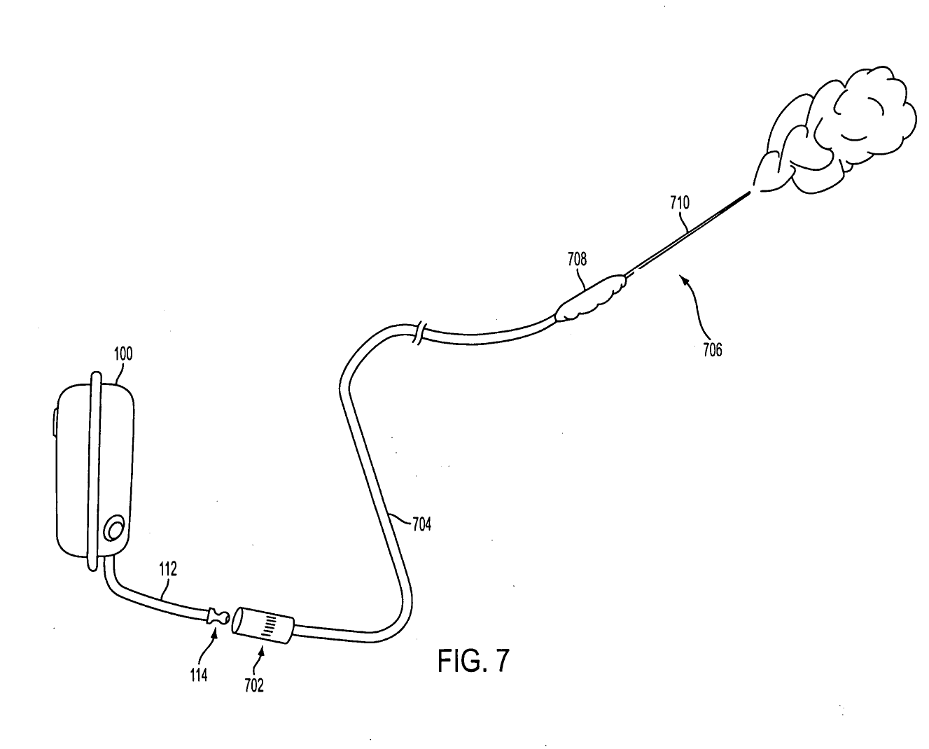

Accessories may also be attached to the apparatus 400 to manipulate and control the direction of the emitted fog. FIG. 7 illustrates an exemplary embodiment of an accessory that is coupleable to the fog exit nozzle 114 according to the present invention. For simplicity, only the heat exchanger 100 is depicted. In this embodiment, a chemical fog can be dispersed through a hand-held fogger wand 706. The accessory includes a coupling 702, a hose 704, and the fogger wand 706. The coupling 702 is located on one end of the hose 704, and the fogger wand 706 is located on the other. The coupling 702 is adapted to be coupled to the fog exit nozzle 114. The fog exit nozzle 114 may be inserted into the coupling 702, thereby allowing fog emitted from the fog exit nozzle 114 to pass into the coupling 702 and into the hose 704. The fog travels through the hose 704 and is dispersed from the fogger wand 706. The fogger wand 706 includes a handle 708 and a dispersion tube 710 with one or more openings that are adapted to emit the fog. A user may direct fog through manipulation of the hand-held fogger wand 706 to a desired location. The fogger wand 706 is also insertable into a receptacle, as will be described below.

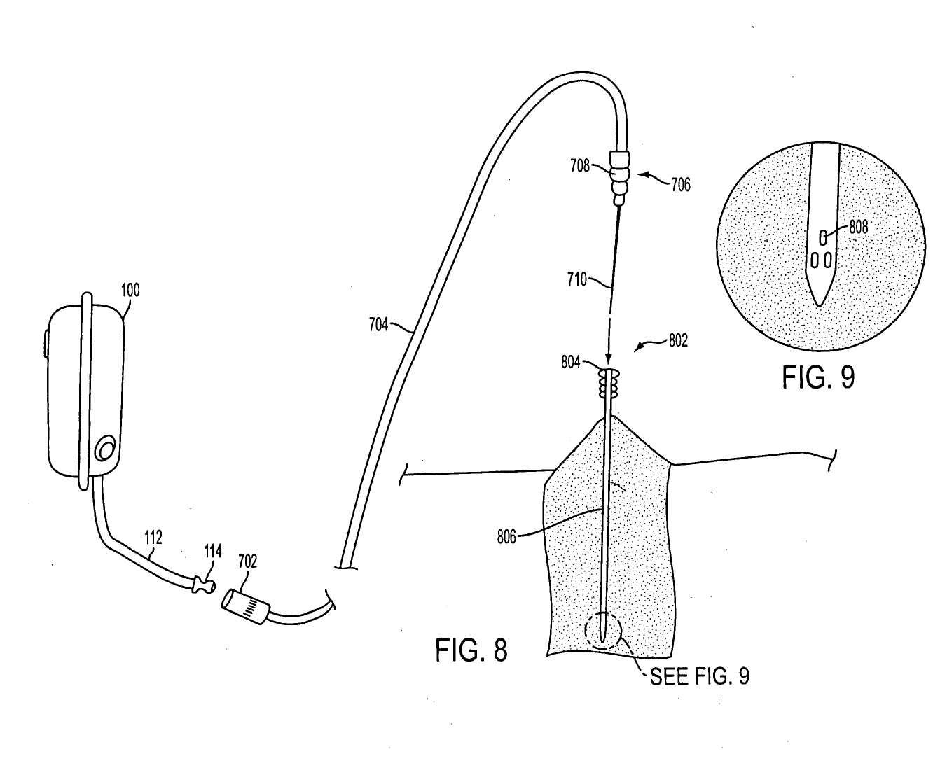

FIG. 8 illustrates an exemplary embodiment for inserting the fogger wand into a receptacle according to the present invention. The dispersion tube 710 of the fogger wand 706 may be inserted into a receptacle 802. The receptacle 802 is adapted for insertion into the ground. The receptacle 802 includes a receptacle input 804 and a receptacle tube 806 that is adapted to be inserted into the ground. The receptacle input 804 guides the dispersion tube 710 of the fogger wand 706 into the receptacle tube 806. When the dispersion tube 710 is fully inserted into receptacle tube 806, the handle 708 of the fogger wand 706 rests against the receptacle input 804 thereby creating a sealed interface that substantially prevents the fog from exiting at the sealed interface. This causes the fog to exit from one or more openings 808 in the base of the receptacle 802 (see FIG. 9). The application shown can be used to disperse an insecticide in the proximity of insects that live underground. For example, the invention can be used to disperse an insecticide in a fire ant bed. In an alternative embodiment of the invention, the receptacle 802 is not used and the dispersion tube 710 of the fogger wand 706 is inserted directly into fire ant bed to distribute the fog.

The embodiments illustrated and discussed in this specification are intended only to teach those skilled in the art the best way known to the inventors to make and use the invention. Nothing in this specification should be considered as limiting the scope of the present invention. All examples presented are representative and not limiting. The above-described embodiments of the invention may be modified or varied, without departing from the invention, as appreciated by those skilled in the art in light of the above teachings. It is therefore to be understood that the invention may be practiced otherwise than as specifically described.

I claim:

1. A heat exchanger comprising:
a nozzle having a first inlet adapted to receive a pressurized chemical and a second inlet adapted to receive a pressurized gas, wherein said pressurized chemical combines with said pressurized gas in said nozzle to form a mist; and
a chamber heated by a heated gas and being coupled to said nozzle, wherein the heated gas vaporizes at least a portion of said mist within said chamber to create a fog.

2. The heat exchanger according to claim 1, further comprising:
a tube heated by said heated gas and being coupled to said chamber, said tube being adapted to receive said mist not vaporized within said chamber and to vaporize at least some of said mist.

3. The heat exchanger according to claim 2, further comprising:
a fog exit nozzle coupled to said tube, said fog exit nozzle being adapted to emit said fog.

4. The heat exchanger according to claim 1, wherein said pressurized chemical is at least one of a herbicide and/or a pesticide.

5. The heat exchanger according to claim 1, wherein said pressurized gas is air.

6. The heat exchanger according to claim 1, wherein the heated gas is exhaust gas from an engine.

7. The heat exchanger according to claim 1, wherein a pressure of said pressurized chemical is approximately 4.5-6 pounds per square inch.

8. The heat exchanger according to claim 1, wherein a pressure of said pressurized gas is between approximately 10 pounds per square inch to approximately 15 pounds per square inch.

9. An apparatus comprising:
an engine adapted to produce a heated gas; and
a heat exchanger coupled to said engine and being adapted to receive said heated gas, said heat exchanger comprising:
a nozzle having a first inlet adapted to receive a pressurized chemical and a second inlet adapted to receive a pressurized gas, wherein said pressurized chemical combines with said pressurized gas in said nozzle to form a mist; and
a chamber heated by the heated gas and being coupled to said nozzle, wherein the heated gas vaporizes at least a portion of said mist to create a fog.

10. The apparatus according to claim 9, wherein said heat exchanger further comprises:
a tube coupled to said chamber, said tube being adapted to receive said fog and to vaporize at least some of the remainder of said mist.

11. The apparatus according to claim 10, wherein said heat exchanger further comprises:
a fog exit nozzle coupled to said tube, said fog exit nozzle being adapted to emit said fog.

12. The apparatus according to claim 11, further comprising:
a coupling coupled to said fog exit nozzle; and
a hose coupled to said coupling, said hose being adapted to receive said fog emitted from said fog exit nozzle.

13. The apparatus according to claim 12, further comprising:
a fog wand coupled to said hose, said fog wand being adapted to emit said fog.

14. The apparatus according to claim 13, wherein said fog wand is adapted to couple with a receptacle that extends underground to emit said fog underground.

15. The apparatus according to claim 9, further comprising:
a needle and hose hub assembly adapted to receive a chemical can.

16. The apparatus according to claim 15, wherein said needle and hose hub assembly includes threading for connecting with said chemical can.

17. The apparatus according to claim 9, further comprising:
a gauge for monitoring a pressure of at least one of said pressurized chemical and/or said pressurized gas.

18. The apparatus according to claim 9, further comprising:
a control adapted to regulate a flow rate of one of said pressurized chemical and/or said pressurized gas.

19. The apparatus according to claim 9, wherein said engine is coupled to a wheel.

20. The apparatus according to claim 9, wherein said engine heats during a preheating cycle.

21. The apparatus according to claim 9, wherein said chamber and said heat exchanger are composed of at least one of a metal, copper, and/or stainless steel.

22. A method comprising:
receiving a pressurized chemical at a first inlet;
receiving a pressurized gas at a second inlet;
combining said first chemical with said second gas to form a mist;
heating a chamber with a heated gas; and
vaporizing at least a portion of said mist in said chamber to generate a fog.

23. The method according to claim 22, further comprising:
receiving said fog in a tube coupled to said chamber; and
emitting said fog from said tube.

24. The method according to claim 22, further comprising:
receiving at least a portion of said mist at a tube;
heating said at least a portion of said mist in said tube to create a fog; and
emitting said fog from said tube.
